(19) United States
(12) Patent Application Publication
(10) Pub. No.: US 2022/0410049 A1
(43) Pub. Date: Dec. 29, 2022

(54) SEALING ARRANGEMENT, FILTER AND FILTER HOUSING, METHOD OF MONITORING LEAK TIGHTNESS, AND LEAK TIGHTNESS MONITORING SYSTEM

(71) Applicant: CAMFIL AB, Stockholm (SE)

(72) Inventors: Yann RENARD, Vagnhärad (SE); Kenny HEDLUND, Trosa (SE); Lionel SAVIN, Singapore (SG); Erik LANS, Västerljung (SE)

(21) Appl. No.: 17/781,647

(22) PCT Filed: Dec. 4, 2020
(86) PCT No.: PCT/SE2020/051171

§ 371 Date: Jun. 1, 2022

(30) Foreign Application Priority Data
Dec. 4, 2019 (SE) 1951394-4

(51) Int. Cl. B01D 46/00; B01D 46/10; F24F 13/28; F24F 3/167

(52) U.S. Cl. CPC B01D 46/0005; B01D 46/10; F24F 13/28; F24F 3/167; B01D 2271/022

(57) ABSTRACT

The disclosure relates to a sealing arrangement comprising a gasket arranged to seal a gap formed between a first element and a second element, wherein the gasket is arranged to be located in the gap and to be in contact with the first and the second elements, where the gasket comprises two elongated gasket members located on a distance from each other so as to form an intermediate gasket space confined by the gasket members and said first and second elements, and in that the sealing arrangement further comprises a pressure source adapted to apply a pressure on the intermediate gasket space, said pressure source preferably being configured to maintain a set pressure difference towards the surroundings. The disclosure further relates to a method, a system, a computer program product arranged to perform the method, a further sealing arrangement and a further method of monitoring sealing integrity of a pharmaceutical production space.

### TECHNICAL FIELD

The present disclosure relates to sealing and monitoring of sealing. More specifically, the disclosure relates to a sealing arrangement, an air filter and a filter housing, a method of monitoring leak tightness of one or more sealing arrangements, a leak tightness monitoring system, a computer program product arranged to perform the method, a sealing arrangement and a method of monitoring sealing integrity of a pharmaceutical production space.

### BACKGROUND ART

In situations where it is necessary to seal off an interior space from the outside, gaskets are commonly used to seal off gaps between structures that enclose such an interior space, to prevent passage of unwanted substances such as particles, fluids, gas or other contaminants through the gap. The gasket can thereby serve to keep the interior space clean, or to prevent unwanted substances from escaping from the interior space. In cases where the sealed off interior space contains equipment and/or substances which are particularly sensitive to contaminants, or contains substances which are hazardous and cannot be allowed to escape into the surrounding environment, it is especially important to ensure that the sealing is sufficiently leak tight. It is also important to ensure that the sealing does not become compromised, and thus it necessary to regularly check the sealing tightness of the gasket, to be able to detect any leakage. Standard methods for leakage detection are available, for example as described in e.g. ISO 10648-2, EN12237 or EN1886.

### SUMMARY

The present disclosure relates to sealing a gap between structural elements and to monitoring of such sealing, and aims at providing improved leak tightness and monitoring of leak tightness to ensure that the sealing is always under control.

Accordingly, the present disclosure relates to a sealing arrangement comprising a gasket arranged to seal a gap formed between a first element and a second element, wherein the gasket is arranged to be located in the gap and to be in contact with the first and the second elements. The gasket comprises two elongated gasket members located at a distance from each other so as to form an intermediate gasket space confined by the gasket members and the first and second elements, and the sealing arrangement further comprises a pressure source adapted to apply a pressure on the intermediate gasket space. The pressure source is preferably configured to maintain a set pressure difference towards the surroundings. The pressure may be an overpressure or an underpressure, which means that the pressure is applied by the pressure source so as to create positive or negative pressure difference relative to the surroundings. This allows for improved prevention of leakage from one side of the gasket to the other of the gasket. Thus, if a leak were to occur between one of the gasket members and the first or second element, or within the gasket members or the first and second elements, the pressure within the intermediate gasket space will prevent any substance from passing through, since the pressure within the intermediate gasket space will force a leaking substance to move in a desired direction by means of the applied pressure.

The present disclosure further relates to a filter for use as the first element in the sealing device, and a filter housing comprising a mounting structure for use as the second element of the filter housing. The filter and filter housing are described I more detail below.

The present disclosure further relates to a method comprising applying a pressure to the intermediate gasket space of one or more sealing arrangements. It also relates to a method of monitoring leak tightness of one or more sealing arrangements as mentioned above, the method comprising applying a pressure to the intermediate gasket space by means of the pressure source; obtaining leakage detection value from a leakage sensor; comparing a leakage detection value with a setpoint value; and if the leakage detection value from the leakage sensor is equal to, or exceeds the setpoint value, generating a message indicating leakage. The method allows for immediate and effective detection of leaks between the gasket and the elements forming the gap sealed by the gasket.

The present disclosure further relates to a system comprising one or more confined volumes, each volume being sealed by a sealing arrangement as defined above; and an evaluation device, wherein the intermediate gasket space of each sealing arrangement that seals each confined volume is preferably connected to the same pressure source, via conduits, and a leakage sensor is located on each conduit between the pressure source and each intermediate gasket space, each leakage sensor comprising a transmitter configured to continuously transmit leakage detection data to the evaluation device, and the evaluation device is configured to continuously receive the leakage detection data. The monitoring system allows for continuous surveillance of the leak tightness of the sealed confined volumes. Thereby, a leak may be immediately detected and dealt with before having caused substantial damage. The evaluation device may comprise a control unit comprising a memory unit and a processor, wherein the memory unit is arranged to be able to store computer readable code that when executed on the processor performs the above method. The control unit may further preferably comprise a communication means arranged to be able to communicate with an external recipient. The present disclosure further relates to a computer program product arranged to perform the above method, when executed in a filter monitoring system as described above.

The present disclosure further relates to a sealing arrangement comprising a gasket arranged to seal a gap formed between a first element and a second element, wherein the gasket is arranged to be located in the gap and to be in contact with the first and the second elements, wherein the first element is comprised in a frame of a filter and the second element is comprised in a mounting structure against which the filter is mounted and where the sealing arrangement includes a means for continuous monitoring of sealing integrity. The filter is typically an air filter comprising an air filter media pack assembly, which is arranged in the frame of the filter.

As mentioned above, the present disclosure also relates to a filter housing configured for mounting of a filter against a mounting structure comprised in the filter housing. The mounting structure is configured to be used as the second element of the above-mentioned sealing arrangement. The filter housing comprises a connection is adapted to be coupled to a pressure source, and being configured to connect an intermediate gasket space to the pressure source. The intermediate gasket space is formed between two elongated gasket members of a gasket arranged between the mounting structure and the filter. The connection may preferably be a channel or conduit arranged through the mounting structure, wherein a first end of the channel or conduit is arranged in a position in the mounting structure that is configured to be located within the intermediate gasket space when a filter is mounted in the filter housing. Alternatively, the connection may preferably be a conduit provided within the filter housing, said conduit comprising an insertion portion configured to be inserted through one of the elongated gasket members of a gasket arranged between the mounting structure and the filter, or in yet an alternative, the filter housing may comprise a connector configured to be connected to a channel or conduit provided in the air filter. The gasket can be provided on the air filter or on the mounting surface of the filter housing.

As mentioned above, the present disclosure also relates to an air filter for use as the first element in the above mentioned sealing arrangement. The air filter is configured to be mounted to a filter mounting structure in a filter housing and comprises a filter frame having an opening in which an air filter media pack assembly is positioned, and a gasket configured to seal a gap between the filter frame and the filter mounting structure in the filter housing. The gasket is attached to the filter frame and is arranged to surround the opening. The gasket comprises two elongated gasket members, where an inner elongated gasket member is configured to surround the opening where the air filter media pack assembly is positioned, and an outer elongated gasket member is configured to surround the inner gasket and the opening. The gasket is attached to the frame so that the elongated gasket members are held in position on a distance from each other so as to form an intermediate gasket space between the gasket members and a surface of the frame onto which the gasket is attached. The air filter comprises a channel or conduit arranged to connect the intermediate gasket space with the surroundings, and is configured to be connected to a pressure source to allow application of pressure on the intermediate gasket space during use. The channel or conduit is arranged through the filter frame, or through one of the elongated gasket member, or is disposed on the surface of the filter frame onto which the elongated gasket members are attached.

The present disclosure further relates to a method of monitoring sealing integrity of a pharmaceutical production space, in which a production batch is produced, wherein the monitoring is performed continuously by means of leak detection using the sealing arrangement. By immediately detect a leak in a sealed pharmaceutical production space, a production batch that has been compromised by leakage can immediately be identified, and unnecessary waste of produced pharmaceutical products can be avoided.

Details of the subject-matter mentioned above will become apparent from the detailed description given below.

### BRIEF DESCRIPTION OF THE DRAWINGS

The features and advantages of the present disclosure will be more fully appreciated by reference to the following illustrative and non-limiting detailed description of example embodiments of the present disclosure, when taken in conjunction with the accompanying drawings.

FIG. 1 shows a perspective view of a sealing arrangement according to the present disclosure;

FIG. 2 shows schematically a sealing arrangement according to the present disclosure;

FIG. 3 shows schematically the steps of an example of a method according to the present disclosure.

FIG. 4a shows schematically a sealing arrangement including a leakage detection device according to the present disclosure.

FIG. 4b shows schematically a sealing arrangement including a leakage detection device according to the present disclosure.

FIG. 5 shows schematically a leak tightness monitoring system according to the present disclosure.

FIG. 6 shows schematically a control unit suitable for use in connection with the leakage detection device of the system illustrated in FIG. 5.

FIG. 7 shows a perspective view of a further sealing arrangement according to the present disclosure

FIG. 8 shows schematically the steps of an example of a further method of monitoring leak tightness according to the present disclosure.

FIGS. 9a-9c and 9a′-9c′ show schematically embodiments of an air filter comprising a two member gasket.

FIG. 10 is a schematic perspective view of an air filter of the present disclosure.

FIG. 11 is a schematic cross-sectional view of a filter housing and an air filter mounted therein.

FIGS. 12a-12b show schematically an embodiment of a filter housing and an air filter mounted therein.

FIG. 13 shows schematically another embodiment of a filter housing and an air filter mounted therein.

FIG. 14 shows schematically yet another embodiment of a filter housing and an air filter mounted therein.

### DETAILED DESCRIPTION

As mentioned above, the present disclosure relates to sealing and monitoring leakage tightness. In many situations it may be necessary to seal off the interior volume of an enclosure or a room from the surrounding environment. This disclosure particularly relates to devices and methods in which a gasket is used to seal a gap between structural elements that enclose such an interior volume, to prevent passage of unwanted substances such as particles, fluids, gas or other contaminants through the gap, and to systems and methods related to that. The gasket serves to seal the gap to prevent any leakage through the gap. Thereby, the interior volume of the enclosure can be kept clean, which is important for example within the pharmaceutical industry or within manufacture of electrical components. Similarly, if the enclosure or room accommodates items or activities, which may release unwanted or hazardous substances, such as for example toxic or pathogenic substances, such substances can be prevented from escaping from the enclosure or room.

It may often be desired or necessary to provide fresh air to the sealed enclosure or room, or to vent out gases there from, also when the enclosure or room must be fully leak proof. In such cases a filter can be mounted in an opening between the interior of the sealed volume and the surrounding. Leakage between the filter and the adjacent structure, against which the filter is mounted, can of course not be accepted, and the gap between a filter frame of the filter and the mounting structure, is thus a position where the devices, systems and methods of the present disclosure may be of particular use. In addition, the devices, systems and methods of the present disclosure allow easy installation of a filter in a filtering equipment where the present sealing principle is applied, which is advantageous since it is important the filter can easily be replaced when needed.

According to the present disclosure an improved sealing arrangement is provided, comprising a gasket arranged to seal a gap formed between a first element and a second element. The first element may typically be a movable or replaceable part, that is mounted to cover an access opening in an enclosure or room, such as for example a filter, or a hatch or door. The second element may typically be a structure against which the first element is held or mounted, such as for example a wall casing of the enclosure or room. The gasket is arranged to be located in the gap formed between a surface of the first element and surface of the second element, and is arranged to be in contact with both the first and second elements. The gasket comprises two elongated gasket members located on a distance from each other so as to form an intermediate gasket space confined by the gasket members and the first and second elements.

The gasket can be any suitable gasket or seal that can be arranged as two elongated members, leaving a space between them. For example, the gasket may be made of e.g. foamed polyurethane, solid polyurethane potting, polyurethane gel, silicone gel, self-adhesive EPDM rubber (ethylene propylene diene monomer rubber), or self-adhesive neoprene. It may be attachable or attached to the surface of one or both of the first and second elements, for example by being made of self-adhesive material or by being attached using an adhesive to one or both of the first and second elements. The gasket should be dimensioned to ensure a sufficient seal in the gap between the surfaces of the first and second elements, i.e. have a length corresponding to the length of the gap and a height exceeding the height of the gap to such an extent that a proper seal is obtained.

The gasket may be comprised of two entirely separate elongated gasket members, which gives flexibility to position the gasket members at different distances from each other, as desired depending on the dimensions of the gap. Alternatively, the two elongated gasket members may be connected to each other by strips or bands having a desired length to facilitate positioning the members at a constant distance from each other in the gap. The distance between the two elongated gasket members may preferably be 0.5 to 100 mm, more preferably 2-90 mm, most preferably 5-50 mm. The height of the gap is the distance between the first element and the second element, and may preferably be 0.5 to 50 mm, more preferably 1-20 mm. The cross-sectional area of the intermediate gasket space may preferably be 0.25 to 5000 mm², more preferably 2-2000 mm².

Typically, the first element is comprised in a frame of a filter, such as an air filter, and the second element is comprised in a mounting structure or housing, against which the filter is mounted, whereby ventilation of a sealed space can be obtained. The gasket may be pre-attached to the filter frame, and be arranged so as to surround the periphery of the filter media pack assembly held by the filter frame. As the two member gasket completely surrounds the opening in the filter frame, leak tightness can effectively be monitored. The area to be sealed by the gasket, i.e. the area surrounded by the gasket, can typically be 250×250 mm to 1300×1900 mm. To the extent the term “filter element” is used herein, it is intended to refer to a filter comprising a filter frame and a filter media pack assembly.

The sealing arrangement further comprises a pressure source adapted to apply a pressure on the intermediate gasket space. The pressure may be an overpressure or an underpressure, which means that the pressure is applied by the pressure source so as to create positive or negative pressure difference relative to the surroundings, i.e. outside of the intermediate gasket space. The pressure can suitably be applied by the pressure source such that the pressure difference between the intermediate gasket space and the surrounding is 50 Pa-1000 kPa, preferably 1 kPa-500 kPa.

As the gasket is comprised of two separate members, the intermediate gasket space is open toward the surfaces of the first and second elements, the application of a pressure to the intermediate gasket space will have the effect that if a leak should arise on either side of the gasket, the pressure within the intermediate gasket space will be affected, such as a leakage flow is pushed back if the applied pressure is an overpressure, or sucked into the intermediate gasket space if the applied pressure is an under pressure as compared to the pressure outside the gasket.

The pressure source is preferably configured to continuously maintain a set pressure difference towards the surroundings to allow continuous improved leak tightness.

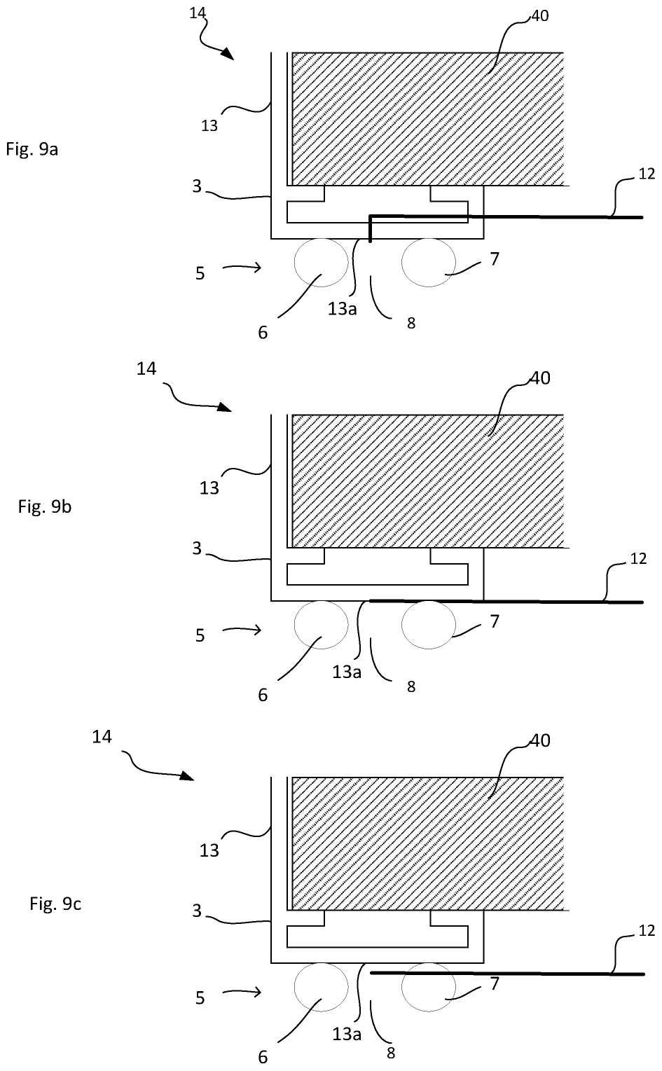

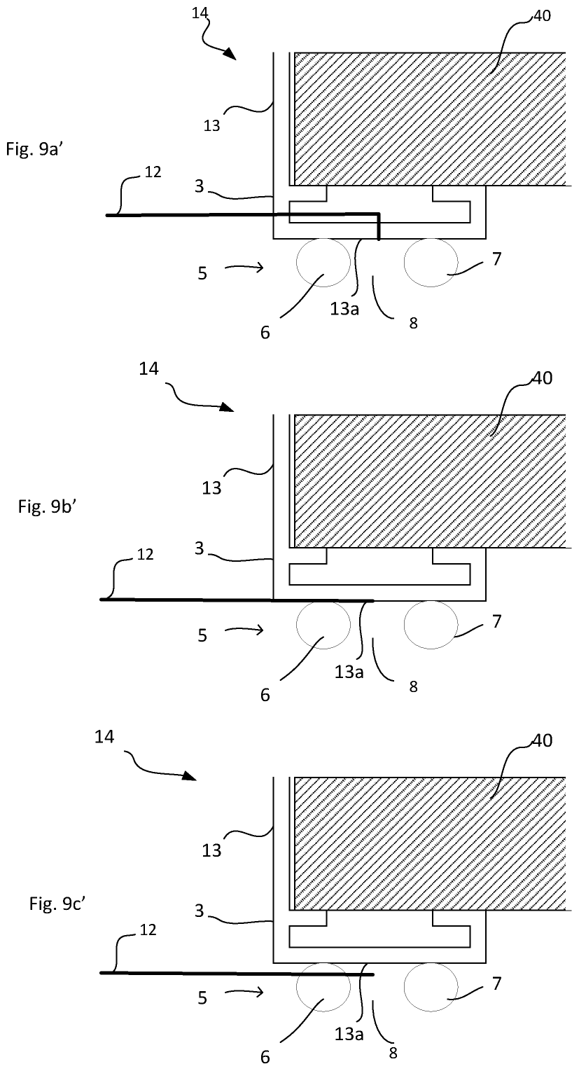

The pressure source is suitably arranged in fluid communication with the intermediate gasket space between the gasket members via a channel or conduit, which may preferably be arranged to be connected to the intermediate gasket space through the mounting structure, or in the form of a tube attached to the filter housing and inserted through one of the gasket members. This allows the sealing arrangement to be used without any need of manipulating the gasket. Alternatively, the channel or conduit may suitably be arranged to be connected to the intermediate gasket space through the frame of a filter, such as an air filter, which enables applying pressure to the intermediate gasket space also in cases where the mounting structure is not, or cannot be, provided with connection to a pressure source. The connection can also be provided in the filter in other ways as described in more detail below and illustrated in the drawings, e.g. FIGS. 9a-9c′ and FIG. 14. In yet an alternative, a separate connection can be provided from a pressure source and inserted into the intermediate gasket space.

The pressure source can be any suitable pressure or vacuum source, such as an air pump or a pressure or vacuum tank, or a centralized compressed air system.

As mentioned above, methods for leakage detection are available, for example according to the standards ISO 10648-2, EN12237 or EN1886. These methods generally include applying a pressure to the interior volume of the sealed enclosure or room to be leak tested, stabilising the pressure and monitoring any changes in the pressure on the volume during a test time period.

The above sealing arrangement according to the present disclosure may advantageously comprise a leakage monitoring device comprising a leakage sensor positioned in the channel or conduit between the pressure source and the intermediate gasket space. The sensor is configured to be able to detect a pressure change within the intermediate gasket space, which is indicative of leakage. When the pressure source is connected to the intermediate gasket space, leakage detection can be available at all times, and can be applied also while the sealed enclosure or room to be tested is in use or operation. Thus, the leakage detection can be applied on the actual equipment to be used, including the seal of the gap during service. No substitute parts, such as blanking plates or the like, need to be used.

The leakage sensor is suitably selected in accordance with the leak tightness requirement set for the sealed enclosure or room, to be able to detect unacceptable leaks. The leakage sensor can be an air flow sensor or a pressure sensor, for example a thermal airflow sensor, pressure drop measurement device for measurement over capillaries or orifices, rotating vane, vortex meter, or ultrasonic flow meter.

Preferably, the leakage monitoring device further comprises a control sensor located between the pressure source and the surroundings, to allow to monitor that the pressure source is operating properly. The control sensor can be selected from the same types as the leakage sensor.

The leakage sensor may be configured to communicate with an evaluation device, such as a computer, to allow remote surveillance of the leakage monitoring. For example the sensor can include a transmitter for wireless communication with a receiver, or the communication can occur via wired connection. The leakage monitoring device further advantageously comprises a backup pressure source arranged parallel to the pressure source, to minimize the risk of pressure failure.

The present disclosure further relates to a method comprising applying a pressure to the intermediate gasket space of one or more sealing arrangements as described above, preferably comprising continuously applying pressure to the intermediate gasket space (8) by means of the pressure source (10).

The method may advantageously include monitoring leak tightness of one or more sealing arrangements as defined above, comprising
obtaining leakage detection value from a leakage sensor,
comparing the leakage detection value with a setpoint value; and
if the leakage detection value from the leakage sensor is equal to, or exceeds the setpoint value, generating a message indicating leakage.

The one or more sealing arrangements monitored by the method can be located in the same or different sealed enclosure or room. The set point values are set corresponding to the leak tightness requirement.

The method suitably comprises obtaining a control value from a control sensor, and if said control value from the control sensor deviates from a control setpoint value, establishing that the pressure source is not operating. The method may further comprise activating the backup pressure source if said control value from the control sensor deviates from said control setpoint value.

Most preferably, the monitoring is performed continuously by continuously applying pressure to the intermediate gasket space by means of the pressure source, and continuously obtaining the leakage detection values from the leakage sensor, and optionally also from the control sensor, and continuously comparing said leakage detection values with setpoint values. By continuously monitoring the leak tightness of the gap sealed by the sealing arrangement, a leak can be immediately detected, and accordingly no backtracking to an earlier leak tightness validation is needed. In the manufacture of products sensitive to contamination, such as pharmaceuticals, the process batch currently being produced when a leak is detected can be identified and be tagged to be checked or disposed of. This can lead to less waste, since only the tagged batch needs to be checked or disposed of, contrary to traditional intermittent leak tightness validation where all batches produced since the last successful validation may be compromised.

A leak tightness monitoring system is also provided according to the present disclosure, comprising one or more confined volumes, and an evaluation device. The confined volumes are enclosures or rooms as discussed above, each comprising a gap sealed by a sealing arrangement as defined above. Each room can include multiple filters or other elements that need to be sealed. The intermediate gasket space of each sealing arrangement that seals each confined volume is connected to a pressure source, via conduits, and a leakage sensor is located on each conduit between the pressure source and the intermediate gasket space, each leakage sensor comprising a transmitter configured to continuously transmit leakage detection data to the evaluation device, and the evaluation device comprising a receiver to continuously receive the leakage detection data. The system thus allows multiple confined volume units to be leak tightness monitored at the same time.

The intermediate gasket space of each sealing arrangement comprised in the system is preferably connected to the same pressure source, for effective application of pressure to all sealing arrangements. The evaluation device advantageously includes a control unit comprising a memory unit and a processor, wherein the memory unit is arranged to be able to store computer readable code that when executed on the processor performs the method of leak tightness monitoring as describe above, thereby enabling automatic surveillance of the leak tightness monitoring. The evaluation device may preferably also include a communication means arranged to be able to communicate with an external recipient, to enable remote surveillance. The evaluation device is suitably configured to evaluate presence of leaks in the gap sealed by the gasket, based on received data from the leakage sensor and/or to evaluate proper operation of the pressure source based on data received from the control sensor. The control unit may also comprise means to transmit a signal to activate the back-up pressure source if needed.

For example, a confined volume comprised in the system can be a containment enclosure, the system comprises a housing and an air inlet opening into which an air filter is fitted, wherein the air filter is sealed to the housing by means of a sealing arrangement as defined above. Another example of a confined volume that can be included in the system is a cleanroom provided with an air filtration arrangement where the system comprises one or more mounting structures wherein air filters are sealed by means of a sealing arrangement as defined above. Yet another example of a confined volume that can be included in the system is a pharmaceutical production space provided with an air filtration arrangement where the system comprises a mounting structure wherein the air filter is sealed to a mounting structure by means of a sealing arrangement as defined above.

The present disclosure further relates to a computer program product arranged to perform the method of monitoring leak tightness described above, when executed in a filter monitoring system as described above and including the mentioned control unit.

As mentioned above, the present disclosure also relates to an air filter for use as the first element in the above mentioned sealing arrangement. The air filter is configured to be mounted to a filter mounting structure in a filter housing and comprises a filter frame having an opening in which an air filter media pack assembly is positioned, and a gasket configured to seal a gap between the filter frame and the filter mounting structure in the filter housing. The air filter media pack assembly can be of any suitable type that is used within air filtration, such as panel type, box type or V type intended to filter a) gaseous or vapor contaminants orb) fine particulate matter, where the latter can have any of the filter classes E10, E11, E12, H13, H14, U15, U16, U17 according to EN1822 or being classified according to ISO 16890. The gasket is attached to the filter frame and is arranged to surround the opening. The gasket comprises two elongated gasket members, where an inner elongated gasket member is configured to surround the opening where the air filter media pack assembly is positioned, and an outer elongated gasket member is configured to surround the inner gasket and the opening. The gasket is attached to the frame so that the elongated gasket members are held in position on a distance from each other so as to form an intermediate gasket space between the gasket members and a surface of the frame onto which the gasket is attached. The air filter comprises a channel or conduit arranged to connect the intermediate gasket space with the surroundings, and is configured to be connected to a pressure source to allow application of pressure on the intermediate gasket space during use. The channel or conduit is arranged through the filter frame, or through one of the elongated gasket member, or is disposed on the surface of the filter frame onto which the elongated gasket members are attached.

The channel or conduit can be configured to be connected to the pressure source on an upstream or a downstream side of the filter. Arranging the connection to the pressure source on the upstream side may be preferred if it is deemed best to keep the pressure equipment on the side of the filter where the material to be filtered off is present. Arranging the connection to the pressure source on the downstream side may be preferred for example if there is no sufficient space for the pressure equipment on the upstream side.

The channel or conduit may also be configured to be directed toward the opening of the filter frame, which may advantageous in case the filter housing was not originally set up for sealing be the above sealing arrangement, and there is only little space between the filter housing and the periphery of the filter.

The channel or conduit may be included in the air filter and be arranged to connect the intermediate gasket space with the surroundings, to allow the intermediate gasket space to be connected to a pressure source. The channel can be arranged through the filter frame, for example as a through bore, or through one of the elongated gasket member, for example in the form of a tube inserted through one of the gasket members, or may be disposed on the surface of the filter frame onto which the elongated gasket members are attached, for example in the form of a groove formed in the surface of the filter frame, or in the form of a tube arranged between the surface of the filter frame and one of the elongated gasket members. By providing the air filter with both the two member gasket and a channel or conduit for connection to a pressure source, the principle of the above sealing arrangement can be applied to air filtration equipment, which was originally not prepared for this, and improved monitoring of leak tightness can thus be obtained.

As mentioned above, the present disclosure also relates to a filter housing configured for mounting of a filter against a mounting structure comprised in the filter housing. The mounting structure is configured to be used as the second element of the above-mentioned sealing arrangement. The filter housing comprises a connection is adapted to be coupled to a pressure source, and being configured to connect an intermediate gasket space to the pressure source. The intermediate gasket space is formed between two elongated gasket members of a gasket arranged between the mounting structure and the filter. The connection may preferably be a channel or conduit arranged through the mounting structure, wherein a first end of the channel or conduit is arranged in a position in the mounting structure that is configured to be located within the intermediate gasket space when a filter is mounted in the filter housing. Alternatively, the connection may preferably be a conduit provided within the filter housing, said conduit comprising an insertion portion configured to be inserted through one of the elongated gasket members of a gasket arranged between the mounting structure and the filter. The conduit provided within the filter housing may be attached to the inside of the filter housing for example by a wire, clamp or glue.

In yet an alternative, the filter housing may comprise a connection in the form of a conduit comprising a connector configured to be connected to a channel or conduit provided in the filter between an intermediate gasket space formed between two elongated gasket members included in the filter. This connection of pressure to the intermediate gasket space also works in a situation where the filter does not include a pre-installed channel or conduit.

An air filtration apparatus may comprising an air filter of the variants described above and a filter housing comprising a mounting structure, wherein the air filter is mounted in the filter housing so that the gasket is located in a gap between the filter and the mounting structure so that the gasket members are in contact with the filter frame and the mounting structure.

A method of installing the air filter in the system of the present disclosure may comprise the steps of: positioning the sealing device in the gap between the filter frame and the mounting structure of the filter housing; mounting the filter frame to the mounting structure so that the gasket members of the sealing device are in contact with the filter frame and the mounting structure; connecting the channel or conduit to the pressure source to allow a pressure to be applied on the intermediate gasket space of the sealing device.

The present disclosure also provides a sealing arrangement comprising a gasket arranged to seal a gap formed between a first element and a second element, wherein the gasket is arranged to be located in the gap and to be in contact with the first and the second elements, wherein the first element is comprised in a frame of a filter, such as an air filter, and the second element is comprised in a mounting structure against which the filter is mounted, and where the sealing arrangement includes a means for continuous monitoring of sealing integrity. The sealing arrangement preferably comprises means to directly detect a loss of sealing integrity. The first element of the sealing arrangement may suitably be comprised in a frame of holding a filter media pack assembly of the panel type, box type or V type intended to filter a) gaseous or vapor contaminants or b) fine particulate matter, the latter having any of the filter classes E10, E11, E12, H13, H14, U15, U16, U17 according to EN1822 or being classified according to ISO 16890.

Further, there is provided a method of monitoring sealing integrity of a pharmaceutical production space, in which a production batch is produced, where the monitoring is performed continuously by means of leak detection using the mentioned sealing arrangement, which includes a means for continuous monitoring of sealing integrity. The method advantageously comprises the step of generating a message indicating leakage if a leak incident is detected, and transferring said message to a control unit being capable to tag said leak incident to the production batch currently produced.

As mentioned above, continuous monitoring of leak tightness of a gap sealed by the defined sealing arrangement, enables a leak to be immediately detected, and accordingly no backtracking to an earlier leak tightness validation is needed. In the manufacture of products sensitive to contamination, such as pharmaceuticals, the process batch currently being produced when a leak is detected can be identified and be tagged to be checked or disposed of. This leads to less waste, since only the tagged batch needs to be checked or disposed of, contrary to traditional intermittent leak tightness validation where all batches produced since the last successful validation must be checked or disposed of.

In the sealing arrangement and method for continuous monitoring sealing integrity all details given above for the first mentioned sealing arrangement, method, system and computer program apply equally.

### DESCRIPTION OF EMBODIMENTS SHOWN IN THE DRAWINGS

The subject-matter of the present disclosure will now be described with reference to the accompanying drawings, in which non-limiting example embodiments of the disclosure are shown. The subject-matter may, however, be embodied in other forms and should not be construed as limited to the herein disclosed embodiments. The disclosed embodiments are provided to fully convey the scope of the disclosure to the skilled person.

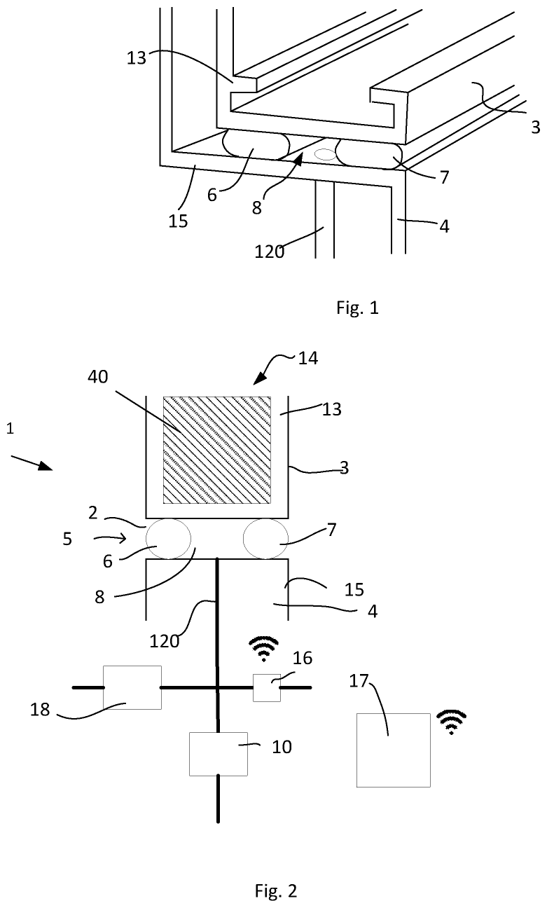

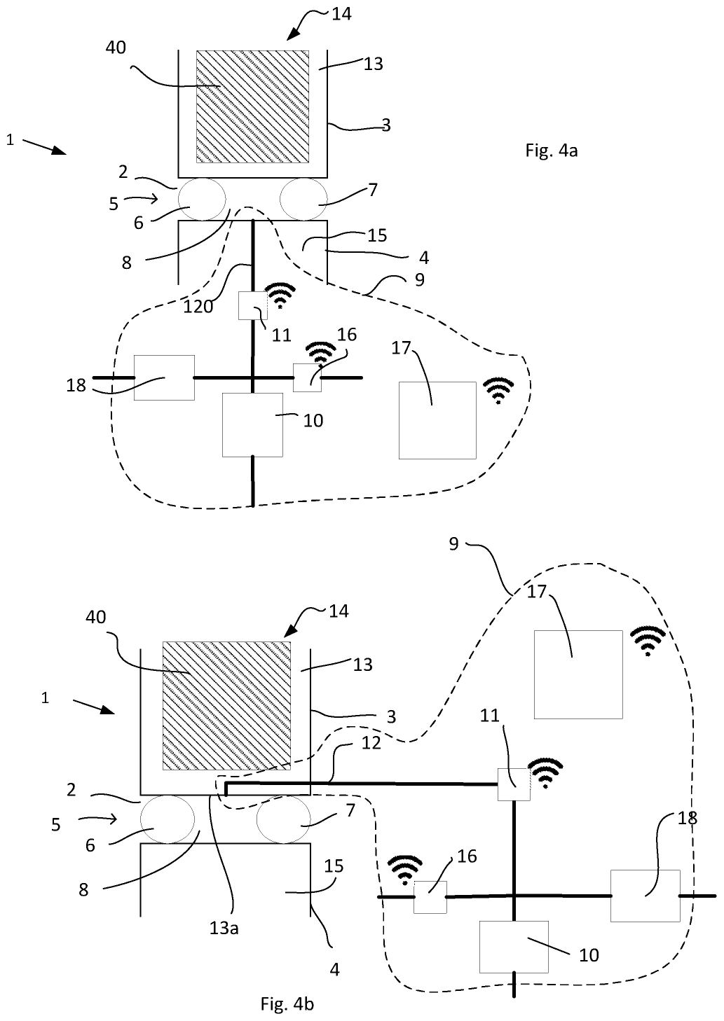

FIG. 1 shows a perspective view of a part of a sealing arrangement according to the present disclosure. FIG. 2 shows schematically a sealing arrangement according to the present disclosure, and FIGS. 4a and 4b show schematically the sealing arrangement including a leakage detection device. In FIG. 4a the pressure source is connected to the intermediate gasket space via the mounting structure 15, and in FIG. 4b, the pressure source is connected to the intermediate gasket space via the filter frame 13. A system comprising one or more volumes including sealing arrangements is shown in FIG. 5. The reference numbers refer to the same or corresponding elements or components in these drawings, although they may be positioned differently.

The sealing arrangement 1 comprises a gasket 5 arranged to seal the gap 2 formed between the first element 3 and the second element 4, wherein the gasket 5 is arranged to be located in the gap 2 and to be in contact with the first and the second elements 3,4. The gasket comprises two elongated gasket members 6,7 located on a distance from each other so as to form an intermediate gasket space 8 confined by the gasket members 6,7 and the first and second elements 3,4. A pressure source 10 (not shown in FIG. 1) is adapted to apply a pressure on the intermediate gasket space 8. The pressure source is arranged in fluid communication with the intermediate gasket space 8 between the gasket members 6,7 via a conduit 12. A leakage monitoring device 9 is included in the sealing arrangement and comprises a leakage sensor 11 positioned in the conduit 12 between the pressure source and the intermediate gasket space 8. As can be seen in FIGS. 2, 4a,b the first element 3 is comprised in a frame 13 of a filter 14 and the second element 4 is comprised in a mounting structure 15 against which the filter is mounted. A filter media pack assembly 40 is mounted in the frame 13. FIG. 1 also shows how the conduit 12 is arranged to be connected to the intermediate gasket space 8 through the mounting structure 15. As illustrated in FIGS. 2, 4a,b, the leakage monitoring device may further comprise an control sensor 16 located between the pressure source and the surroundings. The leakage sensor 11 comprises a transmitter configured to communicate with an evaluation device 17, which comprises a receiver to receive information from the leakage sensor or the control sensor. A backup pressure source 18 is arranged parallel to the pressure source 10.

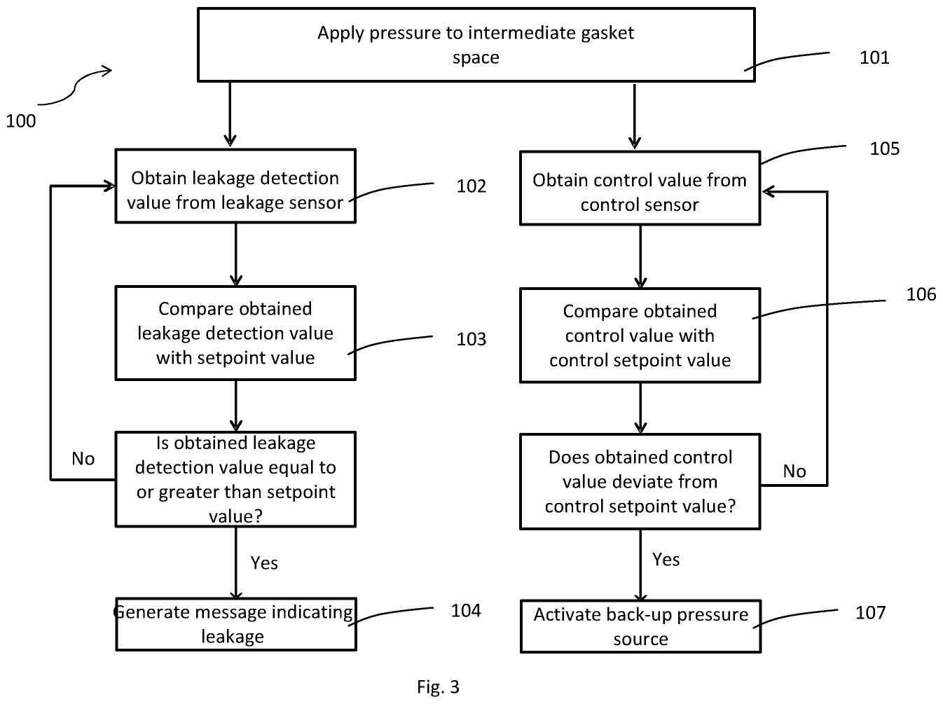

FIG. 3 shows schematically the steps of an example of a method of monitoring leak tightness according to the present disclosure, wherein the method comprises applying a pressure 101 to the intermediate gasket space 8 by means of the pressure source 10, obtaining leakage detection value 102 from the leakage sensor 11; comparing the leakage detection value 103 with a setpoint value; and if the leakage detection value from the leakage sensor 11 is equal to, or exceeds the setpoint value, generating a message 104 indicating leakage. Further steps may be obtaining an control value 105 from an control sensor 16; and, if said control value from the control sensor deviates from a control setpoint value, establishing 106 that the pressure source 10 is not operating. The method can also comprise activating 107 the backup pressure source 18 if said control value from the control sensor deviates from said control setpoint value. The monitoring is preferably performed continuously by continuously applying pressure to the intermediate gasket space 8 by means of the pressure source 10, and continuously obtaining the leakage detection values from the leakage sensor 11, and optionally also from the control sensor 16, and continuously comparing said leakage detection values with setpoint values.

FIG. 5 shows schematically a system according to the present disclosure. The leak tightness monitoring system comprises one or more confined volumes 19a,19b, each volume being sealed by a sealing arrangement as shown in FIGS. 1, 2 and 4a, b, and includes a leak tightness evaluation device 17. The intermediate gasket space 8a,8b of each sealing arrangement that seals each confined volume is connected to a pressure source 10, via conduits 12a,12b, and a leakage sensor 11a,11b is located on each conduit 12a,12b between the pressure source 10 and the intermediate gasket space 8a,8b. The conduits 12a,12b can be arranged in the air filter in various ways, such as those illustrated in FIGS. 9a-9c′, or can be provided in the filter housing as described below.

Each leakage sensor 11a,11b comprises a wired connection or wireless transmitter configured to continuously transmit leakage detection data to the leak tightness evaluation device 17, and the evaluation device 17 comprises a receiver to continuously receive the leakage detection data. The intermediate gasket space 8a,8b of each sealing arrangement is connected to the same pressure source 10. The confined volume 19a,19b schematically shown in FIG. 5 is a containment enclosure, comprising a housing 24 and an air inlet opening 25 into which a filter 26 is fitted. The filter is sealed to the housing by means of a sealing arrangement as illustrated in FIGS. 1, 2 and 4a, 4b.

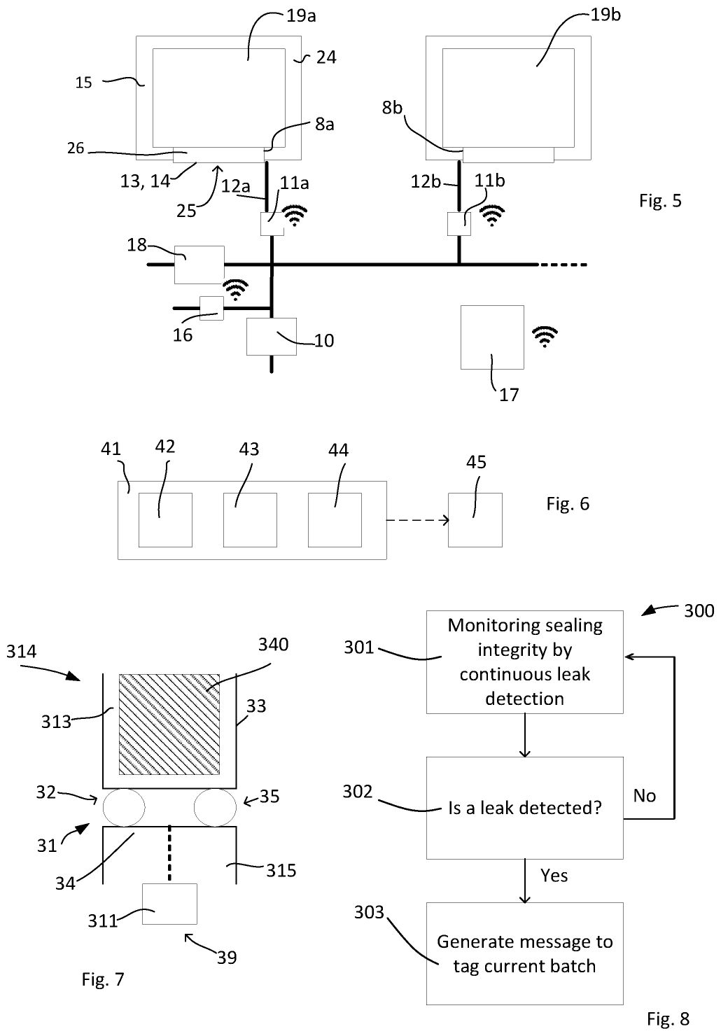

FIG. 6 shows schematically a control unit suitable for use in connection with the leakage detection device of the system illustrated in FIG. 5. The control unit 41 comprises a memory unit 42 and a processor 43, and the memory unit 42 is arranged to be able to store computer readable code that when executed on the processor performs the method monitoring leak tightness. The control unit preferably include communication means 44 arranged to be able to communicate with an external recipient 45.

FIG. 7 shows a perspective view of a further sealing arrangement according to the present disclosure. The sealing arrangement 31 comprises a gasket 35 arranged to seal a gap 32 formed between a first element 33 and a second element 34, and the gasket is arranged to be located in the gap 32 and to be in contact with the first and the second elements 33,34, wherein the first element is comprised in a frame 313 of an air filter 314 and the second element is comprised in a mounting structure 315 against which the air filter is mounted. The sealing arrangement includes a means 39 for continuous monitoring of sealing integrity, which comprises means 311 to directly detect a loss of sealing integrity. In FIG. 7 the gasket is illustrated by two elongated elements, but any suitable seal or gasket may be used.

FIG. 8 shows schematically the steps of an example of a further method of monitoring leak tightness according to the present disclosure. This method is for monitoring sealing integrity of a pharmaceutical production space, in which a production batch is produced, and is performed continuously by means of leak detection 301 using the sealing arrangement shown in FIG. 7. The method may further comprise the step of generating a message 302 indicating leakage if a leak incident is detected, and transferring 303 said message to control unit being capable to tag said leak incident to production batch currently produced.

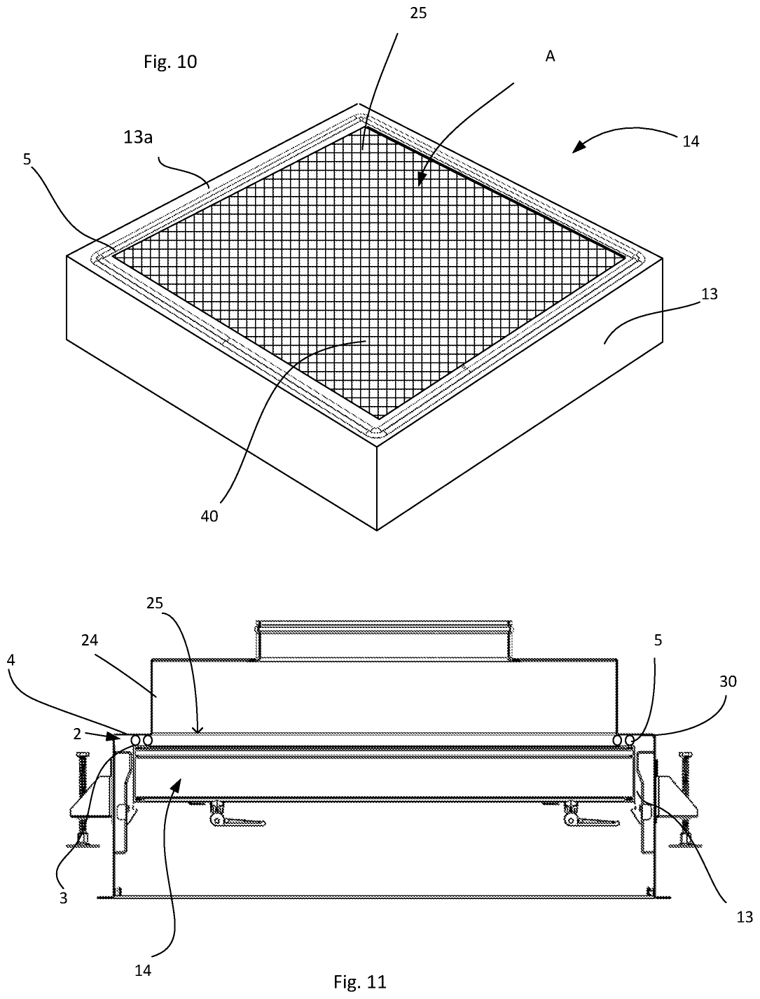

FIGS. 9a-9c and 9a′-9c′ schematically illustrate embodiments of an air filter comprising a two member gasket and where a channel or conduit (12) configured for connection to a pressure source is included in the air filter. FIG. 10 is a schematic perspective view of an air filter.

The air filter 14 is adapted to be used as the first element 3 in the sealing arrangement described above. The air filter 14 is configured to be mounted to the filter mounting structure 30 in the filter housing 24. As shown in FIG. 10, the filter 14 comprises a filter frame 13 having an opening 25 in which an air filter media pack assembly 40 is positioned. A gasket 5 configured to seal a gap 2 between the filter frame and a filter mounting structure 30 in the filter housing 24, is attached to the filter frame 13 and is arranged to surround the opening 25. The gasket 5 comprises two elongated gasket members 6,7, where an inner elongated gasket member 6 surrounds the opening 25 where the air filter media pack assembly 40 is positioned, and an outer elongated gasket member 7 surrounds both the inner gasket 6 and the opening 25. The gasket is attached to the frame so that the elongated gasket members 6,7 are held in position on a distance from each other and an intermediate gasket space 8 is formed between the gasket members 6,7 and a surface 13a of the frame 13 onto which the gasket is attached. The intermediate gasket space 8 is configured to be connected to a pressure source via a channel or conduit 12 to allow application of pressure on the intermediate gasket space 8 during use.

As illustrated in FIGS. 9a-c, 9a′-9c′, the air filter may comprise a channel or conduit 12 arranged to connect the intermediate gasket space 8 with the surroundings (not shown in FIG. 10). The channel 12 may be arranged through the filter frame (FIG. 9a; 9a′), or through one of the elongated gasket members 6,7 (FIG. 9c; 9c′), or is disposed on the surface 13a of the filter frame 13 onto which the elongated gasket members are attached (FIG. 9b; 9b′). The channel or conduit 12 can be directed toward the opening 25 of the filter frame, as illustrated in FIGS. 9a-c or can be directed away from the opening 25 of the filter frame, as illustrated in FIGS. 9a′-9c′. The channel or conduit 12 can be configured to be connected to the pressure source on an upstream or downstream side of the filter depending of the filter application.

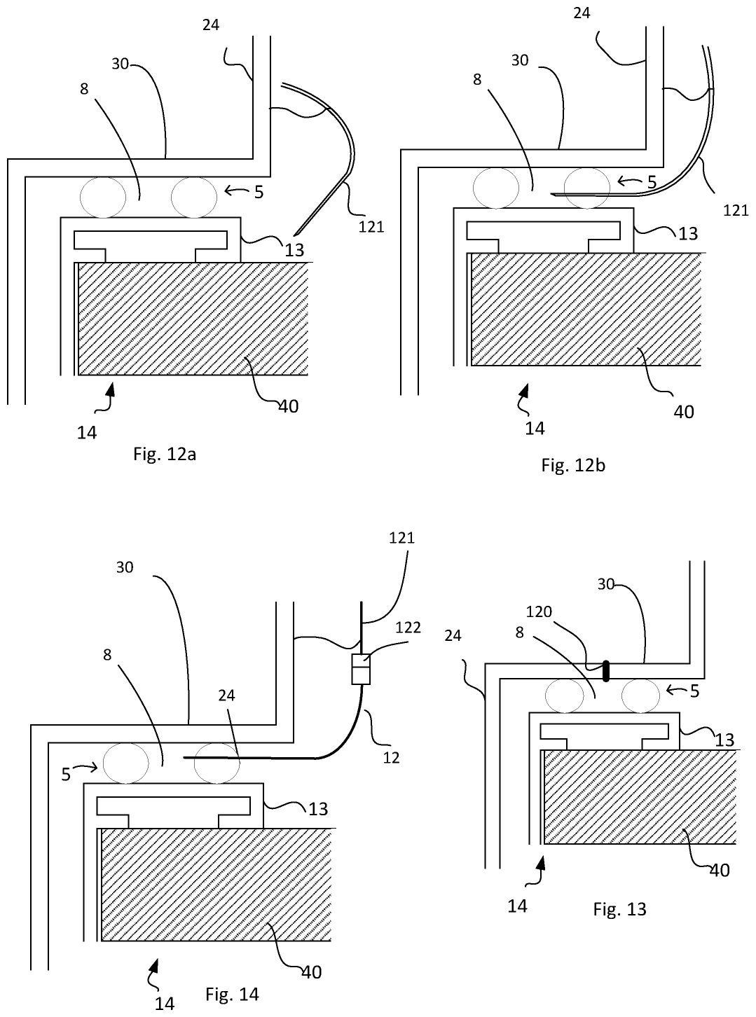

FIG. 11 illustrates how an air filter can be mounted against a mounting structure 30 in a filter housing 24. The connection to a pressure source is not shown in this drawing. FIGS. 12a-12b show schematically an air filter mounted in a filter housing. FIG. 13 shows schematically another filter housing and an air filter mounted therein. An air filtration apparatus includes an air filter 14 and a filter housing 24 comprising a mounting structure 30, wherein the air filter is mounted in the filter housing so that the gasket 5 is located in the gap 2 between the filter and the mounting structure so that the gasket members 6,7 are in contact with the filter frame and the mounting structure.

FIGS. 12a-12b, 13 and 14 show schematically embodiments of a filter housing and an air filter mounted therein. The filter housing 24 is configured for mounting of the filter 14 against a mounting structure 30 comprised in the filter housing. The filter housing comprises a connection adapted to be coupled to a pressure source (not shown) and is configured to connect the intermediate gasket space 8 to the pressure source. As shown the intermediate gasket space 8 is formed between the two members of the gasket 5, which is arranged between the mounting structure 30 and the filter 14. The mounting structure is adapted for use as the second element of the sealing arrangement described above. As illustrated in FIGS. 12a and 12b, a conduit 121 in the form of a tube can be provided within the filter housing and be configured to be inserted through one of the elongated gasket members so that the intermediate gasket space 8 between two elongated gasket members of the gasket 5 can be connected to a pressure source. FIG. 12a shows the housing and the filter before the conduit 121 has been inserted into the intermediate gasket space 8, and FIG. 12b shows the conduit when inserted.

FIG. 13 shows an alternative embodiment of a filter housing configured for mounting of a filter 14 against a mounting structure 15,30 comprised in the filter housing, which can also be used as the second element of the above sealing arrangement can have a channel or conduit 120 arranged through the mounting structure 15,30, whereby the intermediate gasket space 8 between the two elongated gasket members 6,7 of a gasket 5 arranged between the mounting structure 15,30 and the filter 14 can be connected to a pressure source. A mounting structure according to this embodiment is also shown in FIG. 1-2. The gasket 5 can be pre-attached to either of the filter or the mounting structure before assembly.

FIG. 14 shows schematically an embodiment of a filter housing 24 comprising a conduit 121 having a connector 122 configured to be connected to a conduit 12 provided in the filter, where the conduit 12 connects the intermediate gasket space 8 with the surroundings and which can thus be coupled to the pressure source by the connector. The shown example illustrates a conduit 12 pre-arranged through the gasket member. However, all the embodiments shown in FIGS. 9a-9c′ can be attached to a connector in a similar manner.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1-42. (canceled)

43. A method (100) of improving leak tightness in a seal between a frame (13) of a filter element (14) and a mounting structure (15) against which the frame of the filter element is mounted, comprising:
applying a pressure (101) to an intermediate gasket space (8) of one or more sealing arrangements by a pressure source (10), said one or more sealing arrangements (1) comprising a gasket (5) arranged to seal a gap (2) formed between a first element (3) and a second element (4), wherein the gasket is arranged to be located in the gap (2) and to be in contact with the first and the second elements (3,4), the first element being comprised in the frame (13) of the filter element (14) and the second element is comprised in the mounting structure (15) against which the frame of the filter element is mounted, and in that the gasket comprises two elongated gasket members (6,7) located on a distance from each other so as to form an intermediate gasket space (8) confined by the two elongate gasket members (6,7) and said first and second elements (3,4), the sealing arrangement further comprising the pressure source (10) adapted to apply the pressure on the intermediate gasket space (8), said pressure source being configured to maintain a set pressure difference towards a surrounding environment, wherein the sealing arrangement further comprises an control sensor (16) located between the pressure source (10) and the surrounding environment, said control sensor (16) being configured to communicate with an evaluation device (17),
wherein the method comprises continuously applying pressure to the intermediate gasket space (8) by the pressure source (10) and obtaining a control value (105) from a control sensor (16); and, if said control value from the control sensor deviates from a control setpoint value, establishing (106) that the pressure source (10) is not operating.

44. The method of claim 43, comprising continuously obtaining said control values from the control sensor and continuously comparing said control values with the control setpoint values.

45. The method of claim 44, further comprising activating (107) a backup pressure source (18) if said control value from the control sensor (16) deviates from said control setpoint value.

46. The method of claim 43, wherein the pressure is applied by the pressure source (10) to the intermediate gasket space (8) so as to create positive pressure difference relative to the surrounding environment.

47. The method of claim 43, wherein the pressure is applied by the pressure source (10) to the intermediate gasket space (8) so as to create a negative pressure difference relative to the surrounding environment.

48. The method of claim 43, wherein pressure is applied by the pressure source such that the pressure difference between the intermediate gasket space and the surrounding environment is 50 Pa-1000.

49. The method of claim 43, wherein the sealing arrangement further comprises a leakage monitoring device (9) comprising a leakage sensor (11) positioned in a conduit between the pressure source (10) and the intermediate gasket space (8), the method further comprising continuously monitoring of leak tightness by
continuously obtaining a leakage detection values (102) from the leakage sensor (11),
comparing said leakage detection value (103) with a setpoint value; and
if said leakage detection value from the leakage sensor (11) is equal to or exceeds said setpoint value, generating a message (104) indicating leakage.

50. A sealing arrangement (1) comprising:
a gasket (5) arranged to seal a gap (2) formed between a first element (3) and a second element (4), wherein the gasket is arranged to be located in the gap (2) and to be in contact with the first and the second elements (3,4), the first element being comprised in a frame (13) of a filter element (14) and the second element is comprised in a mounting structure (15) against which the frame of filter element is mounted, and in that the gasket comprises two elongated gasket members (6,7) located on a distance from each other so as to form an intermediate gasket space (8) confined by the gasket members (6,7) and said first and second elements (3,4),
wherein the sealing arrangement further comprises a pressure source (10) adapted to continuously apply a pressure on the intermediate gasket space (8), said pressure source being configured to maintain a set pressure difference towards a surrounding environment,
wherein the sealing arrangement further comprises a control sensor (16) located between the pressure source and the surrounding environment, said control sensor (16) being configured to communicate with an evaluation device (17) in order to allow monitoring that the pressure source is operating properly, and
a leakage monitoring device (9) comprising a leakage sensor (11) positioned in a conduit between the pressure source (10) and the intermediate gasket space (8).

51. The sealing arrangement of claim 50, wherein the pressure source is arranged in fluid communication with the intermediate gasket space (8) between the gasket members (6,7) via the conduit (12, 120, 121).

52. The sealing arrangement of, claim 50, wherein the conduit (120) is arranged to be connected to the intermediate gasket space (8) through the mounting structure (15).

53. The sealing arrangement of claim 50, wherein the conduit (12) is arranged to be connected to the intermediate gasket space (8) through the frame (13) of a filter (14).

54. The sealing arrangement of claim 50, further comprising a backup pressure source (18) arranged parallel to the pressure source (10).

55. The sealing arrangement of claim 50, wherein the leakage sensor (11) is an air flow sensor or a pressure sensor.

56. The sealing arrangement of claim 50, further comprising one or more confined volumes (19a,19b), each confined volume being sealed by a respective sealing arrangement, wherein the intermediate gasket space (8a,8b) of each of the respective sealing arrangements is connected to the same pressure source (10).

57. The sealing arrangement of claim 56, further comprising an evaluation device (17); wherein the intermediate gasket space (8a,8b) of each of the respective sealing arrangements is connected to the pressure source (10) via respective conduits (12a,12b), and the leakage sensors (11a,11b) are each located on one of the respective conduits (12a,12b) between the pressure source (10) and the intermediate gasket spaces (8a,8b), each leakage sensor (11a,11b) being configured to continuously transmit leakage detection data to the evaluation device (17), and the evaluation device (17) being configured to continuously receive said leakage detection data.

58. The sealing arrangement of claim 57, wherein the evaluation device (17) comprises a control unit (41) comprising a memory unit (42) and a processor (43) and a communication means (44) arranged to be able to communicate with an external recipient (45), wherein the memory unit (42) is arranged to be able to store computer readable code that when executed on the processor (43) causes performance of at least the following:
continuously applying pressure to the intermediate gasket space by the pressure source and obtaining a control value from the control sensor; and, if the control value from the control sensor deviates from a control setpoint value, establishing that the pressure source is not operating.

59. The sealing arrangement of claim 56, wherein the one or more confined volumes (19a,19b) is a containment enclosure, the containment enclosure comprising a housing (24) and an air inlet opening (25) into which a filter (26) is fitted, wherein the filter is sealed to the housing by the sealing arrangement.

60. The sealing arrangement of claim 56, wherein the one or more confined volumes (19a,19b) is a cleanroom or a pharmaceutical production space provided with an air filtration arrangement comprising the mounting structure, wherein the filter (26) is sealed to the mounting structure by the sealing arrangement.

61. The sealing arrangement of claim 50, wherein the second element of the sealing arrangement is the mounting structure and (15, 30) comprised in a filter housing (24) configured for mounting of an air filter (14), wherein the filter housing comprises a connection (120, 121) adapted to be coupled to the pressure source (10), and being configured to connect the intermediate gasket space (8) to the pressure source, said intermediate gasket space (8) being formed between the two elongated gasket members (6, 7) of the gasket (5) arranged between the mounting structure (15,30) and the filter (14), wherein the connection is the conduit (121) provided within the filter housing, said conduit comprising an insertion portion configured to be inserted through one of the two elongated gasket members (6, 7) of the gasket (5) arranged between the mounting structure (15,30) and the filter (14); or wherein the connection is the conduit (121) comprising a connector (122) configured to be connected to a channel provided in the air filter.

62. The sealing arrangement of claim 50, wherein the first element (3) of the sealing arrangement is an air filter configured to be mounted to a filter mounting structure (15, 30) in a filter housing (24) and comprises:
a filter frame (13) having an opening (25) in which an air filter media pack assembly (40) is positionable;
wherein the gasket is (5) configured to seal the gap (2) between the filter frame and the filter mounting (15, 30) structure in the filter housing (24),
wherein the gasket is attached to the filter frame and is arranged to surround the opening (25);
wherein the gasket (5) comprises the two elongated gasket members (6, 7), where an inner elongated gasket member (6) of the two elongated gasket members is configured to surround the opening (25) where the air filter media pack assembly (40) is positioned, and an outer elongated gasket member (7) of the two elongated gasket members is configured to surround the inner elongated gasket member (6) and the opening (25);
wherein the gasket is attached to the filter frame so that the two elongated gasket members (6,7) are held in position on the distance from each other so as to form the intermediate gasket space (8) between the two elongated gasket members (6,7) and a surface (13a) of the filter frame onto which the gasket is attached;
wherein the air filter comprises a channel (12) arranged to connect the intermediate gasket space (8) with the surrounding environment, and being configured to be connected to a pressure source to allow application of pressure on the intermediate gasket space (8) during use, and
wherein the channel (12) is arranged through the filter frame, or through one of the two elongated gasket members (6, 7), or is disposed on the surface (13a) of the filter frame (13) onto which the two elongated gasket members are attached.
